(19) United States
(12) Patent Application Publication
(10) Pub. No.: US 2010/0052947 A1
(43) Pub. Date: Mar. 4, 2010

(54) CAMERA WITH BUILT-IN LICENSE PLATE RECOGNITION FUNCTION

(75) Inventors: Tsung-Ching LIN, Taipei City (TW); Ju-lung CHEN, Taichung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignees: FARSIGHT INVESTMENT CO., LTD., Taipei (TW); I-SHOU UNIVERSITY, Kaohsiung County (TW)

(21) Appl. No.: 12/202,715

(22) Filed: Sep. 2, 2008

(51) Int. Cl. B60Q 1/48

(52) U.S. Cl. 340/932.2

(57) ABSTRACT

A camera with a built-in license plate recognition function includes a license plate information base, a general purpose input/output (GPIO) port, an image-capturing module, a license plate image processor, a communication module, an audio-capturing module, and a processor. In the camera, the image-capturing module captures a license plate image when determining a vehicle enters/exits from a vehicle access control site; next, the license plate image processor segments and recognizes the image with a conventional image processing technique and compares the image with that in the license plate information base; and then the GPIO port controls the entrance/exit of the vehicle through a collapsible door, a sensor, and an alarm. Furthermore, remote control software may be installed on an external equipment, and the external equipment is connected to the communication module in a wired/wireless manner for achieving remote monitoring.

### BACKGROUND OF THE INVENTION

1. Field of the Invention

The present invention relates to a camera with a built-in license plate recognition function, and more particularly to a camera with a built-in license plate recognition function applied to a vehicle access control site for controlling the entrance/exit of a vehicle.

2. Related Art

Electronic cameras installed on facilities like roads, bridges, or parking lots are critical monitoring and recording equipments, which are used for vehicle access control, traffic monitoring, stolen vehicle searching, or time-based charging on a parking lot by means of a license plate recognition technique on image recognition.

Currently, with the ever-progressing of the license plate recognition technique and rapid development of relevant image process and comparison techniques, the license plate image recognition devices commonly available on the market can reach an accuracy of over 90%. Referring to FIG. 1, the current vehicle control mechanism with image-based license plate automatic recognition operates through a camera 1 combined with a monitoring equipment 2. Particularly, the camera 1 mounted in the control site continuously captures images, and then feeds back the images to the monitoring equipment 2 through wired/wireless network transmission for analysis, comparison, and recognition. Then, subsequent operations are performed, for example, monitoring or controlling periphery devices. However, the above vehicle control mechanism with image-based license plate automatic recognition not only costs a lot of money in manufacturing and mounting equipments such as the camera 1 and the monitoring equipment 2, but also requires experts to install the equipments, which is rather time-consuming. Moreover, after obtaining the images of the control site, the camera 1 has to feed back the images to the remote monitoring equipment 2 for analysis and comparison, which fails to meet the real-time monitoring requirements in modern life.

### SUMMARY OF THE INVENTION

Accordingly, the present invention is directed to a camera with a built-in license plate recognition function mounted on an access control site of a parking garage, which is applicable for automatically detecting a vehicle and capturing a license plate image for recognition, so as to control entrance/exit of the vehicle.

In order to solve the above problem, the present invention provides a camera with a built-in license plate recognition function, which includes a license plate information base, a general purpose input/output (GPIO) port, an image-capturing module, a license plate image processor, a communication module, an audio-capturing module, and a processor, and is mounted on a vehicle access control site for controlling entrance/exit of vehicles. In the camera with a built-in license plate recognition function provided by the present invention, the image-capturing module obtains continuous frames of the control site, and calculates the continuous frames with image-based motion detection software installed therein, so as to determine whether a vehicle is approaching the control site or not. When it is determined that a vehicle is approaching the control site, a decision mechanism is employed to select an appropriate vehicle image from the plurality of continuous frames. Then, the license plate image processor captures a license plate image from the vehicle image, recognizes the license plate image by segmenting a letter image and numeral image on the license plate image with a conventional image processing technique, then compares the images with that in the license plate information base through an artificial intelligence technique to determine whether the number on the license plate matches at least one pre-stored reference number in the license plate information base or not, and finally uses the GPIO port to control the entrance/exit of the vehicle by means of a collapsible door, a sensor, and an alarm.

Furthermore, in the present invention, an external equipment such as a computer, a mobile communication device, or a personal digital assistant (PDA) installed with remote control software is connected to the communication module through transmission control protocol/internet protocol (TCP/IP) or a wireless local area network (WLAN) for achieving remote monitoring. For example, when the external equipment issues a monitoring message to the camera with a built-in license plate recognition function, the image-capturing module, the audio-capturing module, and the processor obtain an audio-visual message of the vehicle access control site, and then encode/decode and feed back the message to the external equipment.

In view of the above, the camera with a built-in license plate recognition function provided by the present invention first automatically senses that a vehicle is approaching the vehicle access control site, captures a vehicle image, positions the license plate, and recognizes the number on the license plate, and then compares the number with certain reference number pre-stored in the license plate information base, so as to control the entrance/exit of the vehicle. Moreover, remote control software can be adopted in the present invention to issue a command to instruct the camera with a built-in license plate recognition function to perform remote monitoring, thus making the vehicle access control more practical and alleviating the supervisors' burden.

### BRIEF DESCRIPTION OF THE DRAWINGS

The present invention will become more fully understood from the detailed description given herein below for illustration only, and thus is not limitative of the present invention, and wherein:

FIG. 1 is a camera with a built-in license plate recognition function in the prior art;

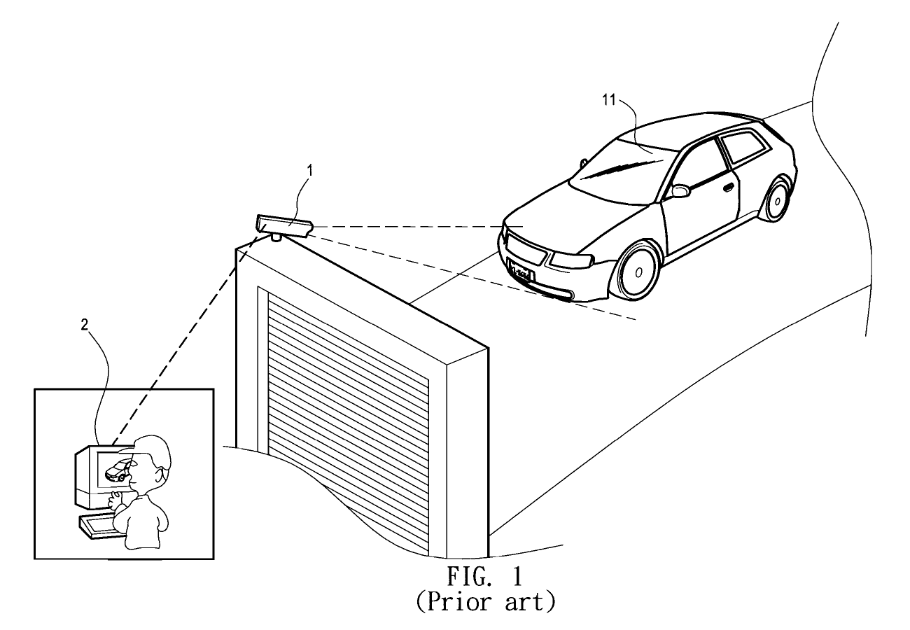

FIG. 2 is a schematic view of a camera with a built-in license plate recognition function according to an embodiment of the present invention;

FIG. 3 is a block view of modules of a camera with a built-in license plate recognition function according to an embodiment of the present invention;

FIG. 4 is a schematic view of remote control of a camera with a built-in license plate recognition function according to an embodiment of the present invention; and

FIG. 5 is a schematic view of remote control software of a camera with a built-in license plate recognition function according to an embodiment of the present invention.

### DETAILED DESCRIPTION OF THE INVENTION

In order to make the content of the present invention comprehensible, embodiments accompanied with figures are described in detail below.

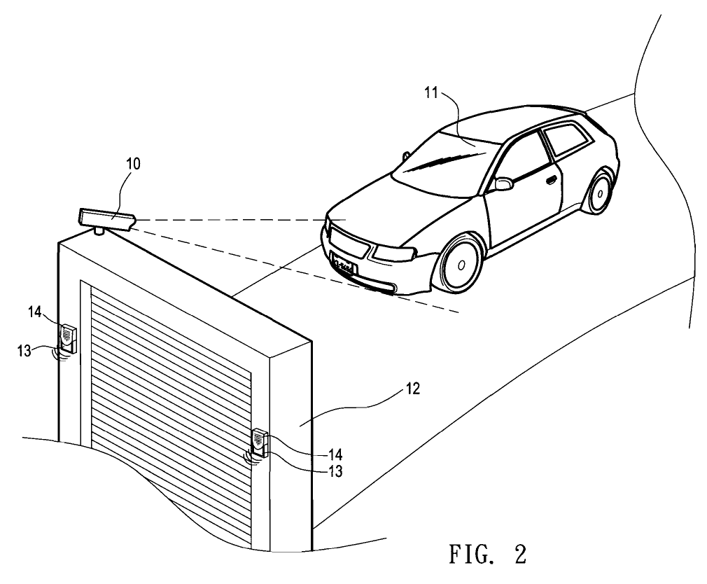

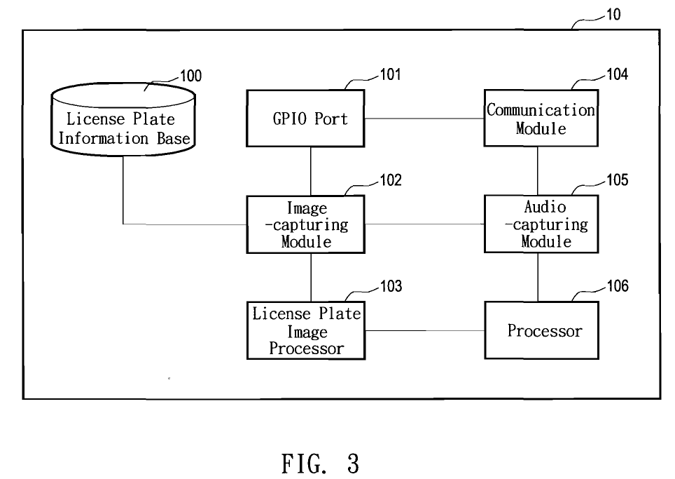

FIG. 2 is a schematic view of a camera with a built-in license plate recognition function according to an embodiment of the present invention, and FIG. 3 is a block view of modules of a camera with a built-in license plate recognition function according to an embodiment of the present invention. Referring to FIGS. 2 and 3, the camera 10 with a built-in license plate recognition function mainly includes a license plate information base 100, a GPIO port 101, an image-capturing module 102, a license plate image processor 103, a communication module 104, an audio-capturing module 105, and a processor 106, and is mounted on an access control site of a parking garage, which is used for controlling entrance/exit of a vehicle 11 passing through the control site, as well as other appropriate applications.

According to the camera 10 with a built-in license plate recognition function, the image-capturing module 102 first uninterruptedly captures a plurality of continuous frames of the place where the camera 10 is mounted. Then, the image-based motion detection software stored in the image-capturing module 102 converts each frame into a grayscale, and performs a subtraction operation on each pixel value with the same coordinates between the frames, so as to obtain a difference. If the difference exceeds a default threshold value, it indicates a vehicle is approaching the garage. At this time, a decision mechanism such as majority voting, neural networks, or Bayesian decision is employed to select the most appropriate vehicle image from the plurality of continuous frames. Afterwards, the license plate image processor 103 takes an area with the same size as a license plate from the selected vehicle image to serve as a license plate image, removes undesired information such as the background image or images of the tapped holes by a conventional image processing technique, and then segments letter images and numeral character images on the license plate image to be recognized one by one and then combined into the number of the license plate. Next, an artificial intelligence technique such as neural networks is employed to compare the above obtained number with that in the license plate information base 100, so as to determine whether the number on the license plate matches at least one pre-stored reference number in the license plate information base 100 or not. When the number on the license plate matches at least one pre-stored reference number, the GPIO port 101 outputs an enable signal to turn on a collapsible door 12 at the access control site of the parking garage to let the vehicle 11 pass. On the contrary, when the number on the license plate does not match any of the pre-stored reference numbers, the GPIO port 101 outputs an enable signal to actuate security protection devices such as a sensor 13 and an alarm 14 to perform safety guard. Therefore, if the vehicle 11 tries to break into the garage, the sensor 13 and the alarm 14 are actuated to make an alert, and the communication module 104 also sends a message to inform relevant personnel to take necessary measures.

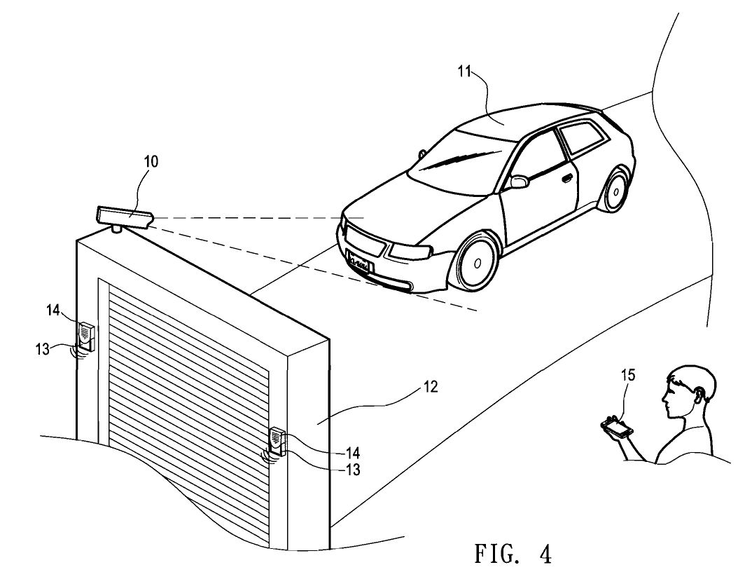

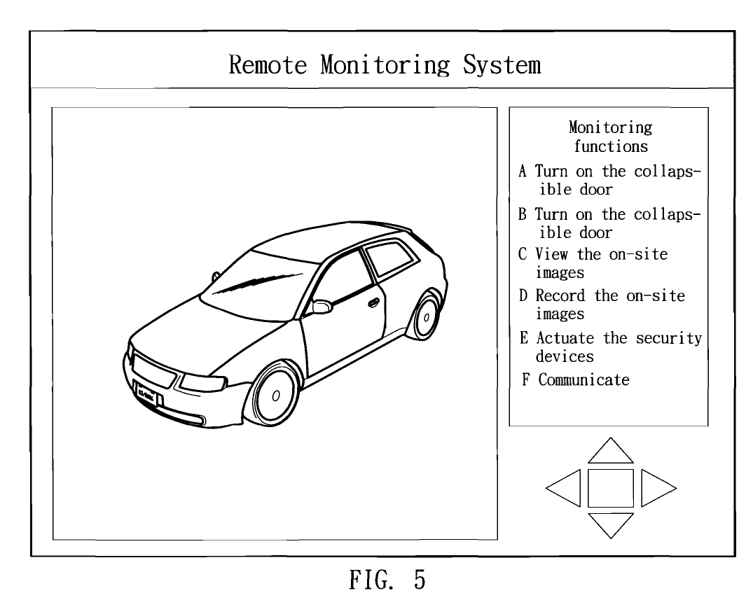

FIG. 4 is a schematic view of remote control of a camera with a built-in license plate recognition function according to an embodiment of the present invention, and FIG. 5 is a schematic view of remote control software of a camera with a built-in license plate recognition function according to an embodiment of the present invention. In the camera 10 with a built-in license plate recognition function, an external equipment 15, such as a computer, a mobile communication device, or a PDA installed with the remote control software, is connected to the communication module 104 through TCP/IP or WLAN, so as to issue a monitoring message to instruct the image-capturing module 102 and the audio-capturing module 105 to capture a real-time audio-visual message of the site where the camera 10 with a built-in license plate recognition function is mounted. Next, the processor 106 encodes/decodes the message, and then the communication module 104 feeds back the message to the external equipment 15 for remote monitoring. Alternatively, the remote control software is operated to issue a monitoring message to control the GPIO port 101 to turn on/turn off the collapsible door 12 or to snap-shoot a license plate image of the vehicle 11.

In addition, the image-capturing module 102 is constituted by charge-coupled device (CCD) sensing elements or complementary metal-oxide semiconductor (CMOS) sensing elements.

In view of the above, the camera 10 with a built-in license plate recognition function provided by the present invention first automatically senses whether a vehicle 11 is approaching the vehicle access control site or not, then captures a vehicle image, positions the license plate, and recognizes the number on the license plate, and then searches the license plate information base 100 to see whether a matching reference number exists or not, so as to control the entrance/exit of the vehicle 11. Moreover, remote control software is employed to capture an audio-visual message of the site where the camera 10 with a built-in license plate recognition function is mounted, so as to turn on/turn off the collapsible door 12, thereby facilitating and enhancing the reliability of the vehicle access control.

Though the present invention has been disclosed above by the preferred embodiments, they are not intended to limit the present invention. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A camera with a built-in license plate recognition function, suitable for controlling a vehicle to enter/exit from a parking garage, the camera comprising:
a license plate information base;
a general purpose input/output (GPIO) port;
an image-capturing module, for automatically detecting a vehicle through image-based motion detection software, so as to capture a license plate image; and
a license plate image processor, for positioning the license plate image, identifying a number on the license plate, and opening a collapsible door through the GPIO port after the number on the license plate is determined to match at least one pre-stored reference number in the license plate information base.

2. The camera with a built-in license plate recognition function according to claim 1, wherein the image-capturing module further snap-shoots the license plate image, when the license plate image processor determines that the number on the license plate matches the pre-stored reference number in the license plate information base.

3. The camera with a built-in license plate recognition function according to claim 1, wherein the GPIO port further actuates a security protection device, when the license plate image processor determines that the number on the license plate does not match the pre-stored reference number in the license plate information base.

4. The camera with a built-in license plate recognition function according to claim 1, further comprising:
a communication module, connected to an external equipment in a wired/wireless manner;
an audio-capturing module; and
a processor, for parsing a monitoring message received by the communication module from the external equipment, then controlling the image-capturing module and the audio-capturing module to obtain an image and sounds of a site where the camera with a built-in license plate recognition function is mounted, and then encoding/decoding and feeding back the image and sounds to the external equipment through the communication module.

5. The camera with a built-in license plate recognition function according to claim 4, wherein the communication device is connected to the external equipment in a wired manner through transmission control protocol/internet protocol (TCP/IP).

6. The camera with a built-in license plate recognition function according to claim 4, wherein the communication device is connected to the external equipment in a wireless manner through a wireless local area network (WLAN).

7. The camera with a built-in license plate recognition function according to claim 4, wherein the external equipment is a computer.

8. The camera with a built-in license plate recognition function according to claim 4, wherein the external equipment is a mobile communication device.

9. The camera with a built-in license plate recognition function according to claim 4, wherein the external equipment is a personal digital assistant (PDA).

10. The camera with a built-in license plate recognition function according to claim 4, wherein the image-capturing module further snap-shoots the license plate image when the communication module receives the monitoring message issued by the external equipment.

11. The camera with a built-in license plate recognition function according to claim 4, wherein the external equipment is connected to the communication module in a wired/wireless manner, so as to transmit the monitoring message to the GPIO port for opening/closing the collapsible door.

12. The camera with a built-in license plate recognition function according to claim 1, wherein the image-capturing module is formed by charge-coupled device (CCD) sensing elements.

13. The camera with a built-in license plate recognition function according to claim 1, wherein the image-capturing module is formed by complementary metal-oxide semiconductor (CMOS) sensing elements.

14. The camera with a built-in license plate recognition function according to claim 1, wherein the license plate image comprises at least one letter from A to Z and a plurality of numerals from 0 to 9.
